(19) United States
(12) Patent Application Publication
(10) Pub. No.: US 2025/0044582 A1
(43) Pub. Date: Feb. 6, 2025

(54) OPTICAL SCANNING APPARATUS

(71) Applicant: BROTHER KOGYO KABUSHIKI KAISHA, Nagoya (JP)

(72) Inventor: Naoya HIGASHIHARA, Toyoake (JP)

(73) Assignee: BROTHER KOGYO KABUSHIKI KAISHA, Nagoya (JP)

(21) Appl. No.: 18/768,604

(22) Filed: Jul. 10, 2024

(30) Foreign Application Priority Data
Jul. 31, 2023 (JP) 2023-124032

(51) Int. Cl. G02B 26/12; G02B 26/10

(52) U.S. Cl. CPC G02B 26/124; G02B 26/105

(57) ABSTRACT

An optical scanning apparatus includes a semiconductor laser, a coupling lens, a deflector including a polygon mirror which is rotatable about a rotation axis extending in a first direction, a scanning optical system to form an image of a light beam deflected by the deflector on an image surface, a frame including a base board, and a cover covering the deflector. The frame includes a first wall extending in a direction from the base board toward the cover. The first wall includes an opening, through which the light beam deflected by the deflector toward the scanning optical system passes, and a first cutout located apart from the opening in a second direction parallel to the main scanning direction. The cover includes a second wall covering an entirety of the first cutout in a view along a third direction, which intersects orthogonally with the first direction and the second direction.

### REFERENCE TO RELATED APPLICATIONS

This application claims priority from Japanese Patent Application No. 2023-124032, filed on Jul. 31, 2023. The entire content of the priority application is incorporated herein by reference.

### BACKGROUND ART

An optical scanning apparatus including a coupling lens, a deflector with a polygon mirror, a scanning optical system, and a frame is known. The coupling lens may convert light from a semiconductor laser into a light beam, the deflector may deflect the light beam from the coupling lens, and the scanning optical system may focus the light beam deflected by the deflector on an image surface. The frame retains the coupling lens, the deflector, and the scanning optical system.

### SUMMARY

When, for example, a reflectance rate of the polygon mirror is lowered due to dust adhering to a surface of the polygon mirror, optical performance of the polygon mirror may be lowered.

The present disclosure relates to an optical scanning apparatus, in which dust may be prevented from adhering to the polygon mirror.

According to an aspect of the present disclosure, an optical scanning apparatus includes a semiconductor laser, a coupling lens, a deflector, a scanning optical system, a frame, and a cover. The coupling lens is configured to convert light emitted from the semiconductor laser into a light beam. The deflector is configured to deflect the light beam passed through the coupling lens into a main scanning direction and includes a polygon mirror, which is rotatable about a rotation axis extending in a first direction. The scanning optical system is configured to focus the light beam deflected by the deflector on an image surface. The frame includes a base board, on which the deflector is mounted. The cover covers the deflector from a side opposite to the base board. The frame includes a first wall extending in a direction from the base board toward the cover. The first wall includes an opening, through which the light beam deflected by the deflector toward the scanning optical system passes, and a first cutout located apart from the opening in a second direction. The second direction is parallel to the main scanning direction. The cover includes a second wall covering an entirety of the first cutout in a view along a third direction. The third direction intersects orthogonally with the first direction and the second direction.

An optical scanning apparatus includes a light source emitting a light beam, a polygon mirror deflecting the light beam into a main scanning direction, the polygon mirror being rotatable about a rotation axis, a motor rotating the polygon mirror, a scanning optical system converging the light beam deflected by the polygon mirror on an image surface, a frame including a base board, on which the motor is mounted, and a cover covering the polygon mirror from a side opposite to the base board. The frame includes a partition wall extending in a direction from the base board toward the cover. The partition wall surrounds a chamber which accommodates the polygon mirror. The partition wall includes a first cutout located outside of a scanning range of the light beam in the main scanning direction. The cover includes a second wall. The second wall closes the first cutout.

### BRIEF DESCRIPTION OF DRAWINGS

FIG. 1 is a perspective view of an optical scanning apparatus showing one side in a first direction.

FIG. 2 is a perspective view of the optical scanning apparatus showing the other side in the first direction.

FIG. 3 is a cross-sectional view of the optical scanning apparatus sectioned along a line A-A in FIG. 1.

FIG. 4 is a perspective view of the optical scanning apparatus without a cover.

FIG. 5 is a perspective view of the optical scanning apparatus without the cover and without second scanning lenses.

FIG. 6 is a perspective view of the cover showing one side in the first direction.

FIG. 7 is a plan view of the cover showing the other side in the first direction.

FIG. 8 is a cross-sectional view of the optical scanning apparatus and the cover sectioned along a line C-C in FIG. 5.

FIG. 9 is a cross-sectional view of the optical scanning apparatus, with the cover attached, sectioned along the line C-C in FIG. 5.

FIG. 10 is a cross-sectional view of the optical scanning apparatus, without the cover, sectioned along a line D-D in FIG. 5.

FIG. 11 is a cross-sectional view of the optical scanning apparatus, without the cover, sectioned along a line E-E in FIG. 10.

### DESCRIPTION

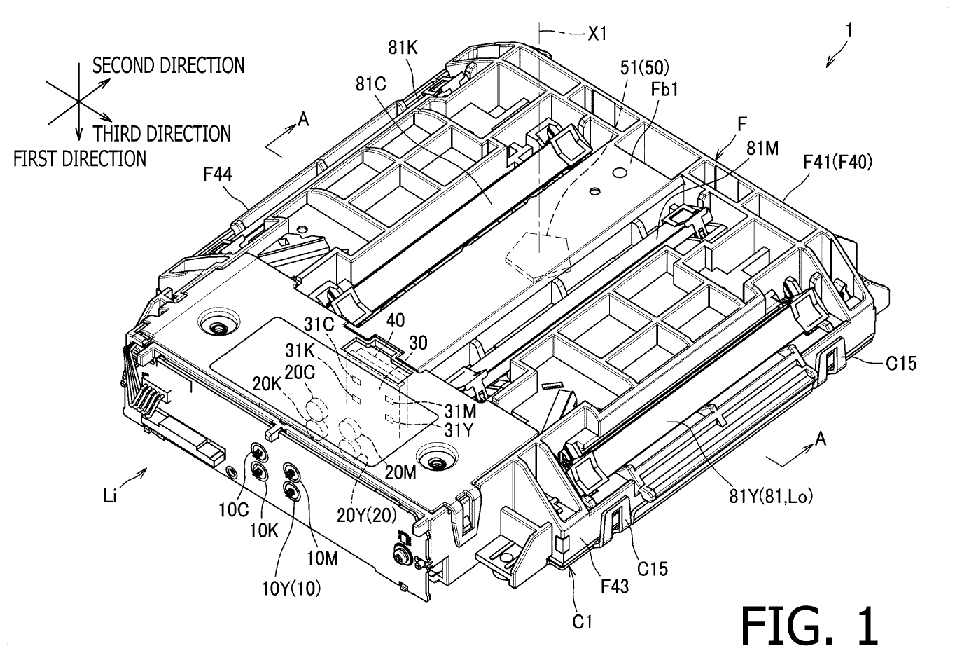

As shown in FIG. 1, an optical scanning apparatus 1 includes a frame F, a cover C1, an incident optical system Li, a deflector 50, and a scanning optical system Lo. The optical scanning apparatus 1 is applicable to an electro-photographic image forming apparatus. In the following context, a direction along a rotation axis X1 f a polygon mirror 51 in the deflector 50 will be referred to as a first direction. A direction orthogonal to the first direction and parallel to a main scanning direction, into which the deflector 50 deflects a light beam, will be referred to as a second direction. A direction intersecting orthogonally with the first direction and the second direction will be referred to as a third direction. Arrows labeled “first direction,” “second direction,” and “third direction” in the accompanying drawings point toward one side in the first direction, one side in the second direction, and one side in the third direction, respectively, in the optical scanning apparatus 1. Sides opposite to the one sides in the first direction, the second direction, and the third direction will be referred to as the other sides in the first direction, the second direction, and the third direction, respectively.

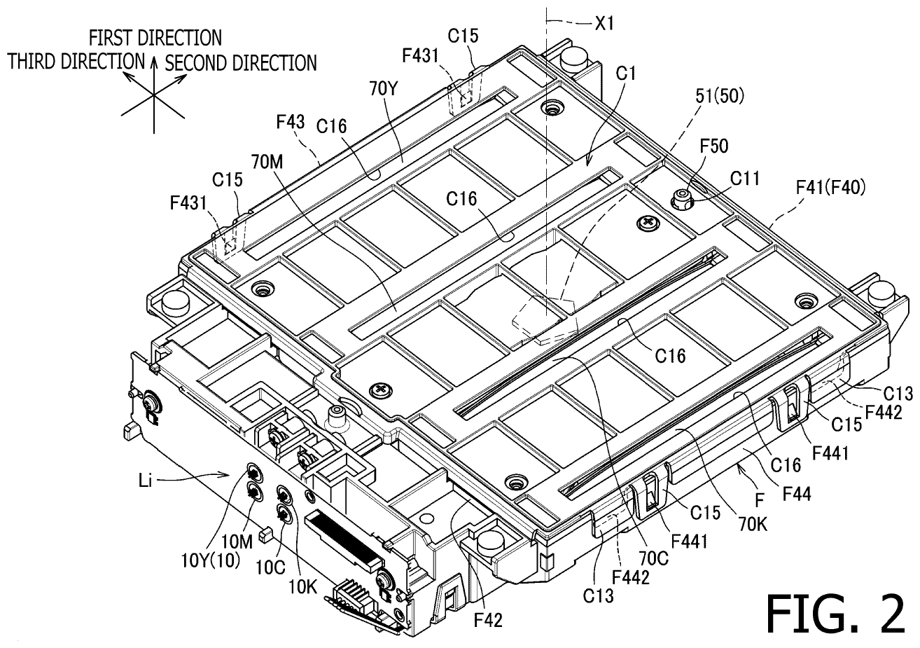

The frame F and the cover C1 form a housing of the optical scanning apparatus 1 (see also FIG. 2). As will be described in detail later, the incident optical system Li, the deflector 50, and the scanning optical system Lo are accommodated in the housing formed of the frame F and the cover C1.

The incident optical system Li includes four semiconductor lasers 10, four coupling lenses 20, an aperture plate 30, and a condenser lens 40.

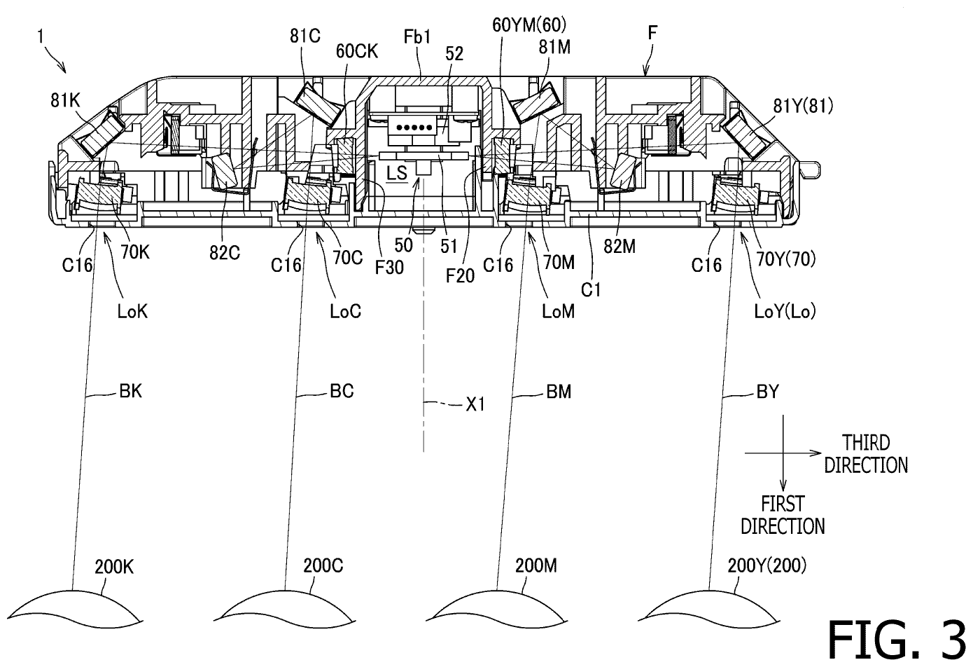

The semiconductor lasers 10 may emit light. Four semiconductor lasers 10 are provided to four photosensitive drums 200 (see FIG. 3) in one-to-one correspondence to irradiate and scan the respective ones of the photosensitive drums 200 with the light. On the photosensitive drums 200, images may be formed in toners in different colors.

In the present embodiment, the different colors are yellow (Y), magenta (M), cyan (C), and black (K), which may be referred to as first color, second color, third color, and fourth color, respectively. In the following description, the colors of yellow, magenta, cyan, and black related to specific parts and members in the optical scanning apparatus 1 may be expressed by the ordinal numbers “first,” “second,” “third,” and “fourth,” respectively, which precede the names of the parts or members, and by the reference sings Y, M, C, K appended to the reference numbers that follow the names of the parts and the members.

A first semiconductor laser 10Y aligns with a second semiconductor laser 10M, at a position apart from the second semiconductor laser 10M, along the first direction. The first semiconductor laser 10Y is located on the one side in the first direction with respect to the second semiconductor laser 10M.

A third semiconductor laser 10C aligns with the second semiconductor laser 10M, at a position apart from the second semiconductor laser 10M, along the third direction. The third semiconductor laser 10C is located on the other side in the third direction with respect to the second semiconductor laser 10M. A fourth semiconductor laser 10K aligns with, and is apart from, the third semiconductor laser 10C along the first direction and aligns with, and is apart from, the first semiconductor laser 10Y in the third direction.

The coupling lenses 20 convert light emitted from the semiconductor lasers 10 into light beams. The coupling lenses 20Y, 20M, 20C, 20K corresponding to yellow, magenta, cyan, and black, respectively, are located at positions to face the first-fourth semiconductor lasers 10Y, 10M, 10C, 10K, respectively. The coupling lens 20Y and the first semiconductor laser 10Y, the coupling lens 20M and the second semiconductor laser 10M, the coupling lens 20C and the third semiconductor laser 10C, and the coupling lens 20K and the fourth semiconductor laser 10K each form a light source.

The aperture plate 30 is a piece formed integrally with the frame F and has apertures 31, through which the light beams from the coupling lenses 20 may pass. The aperture plate 30 is located between the coupling lenses 20 and the condenser lens 40.

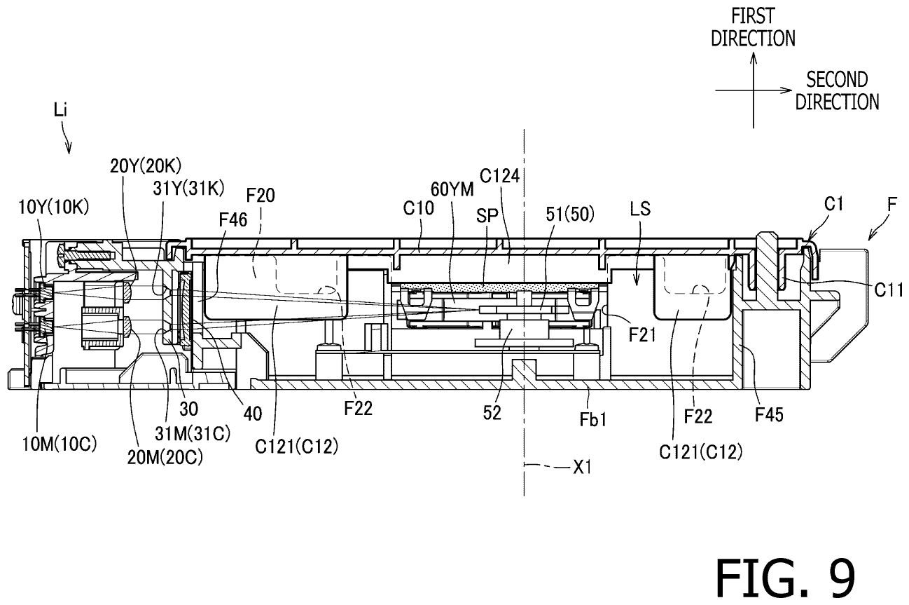

The condenser lens 40 condenses the light beams, which enter from the coupling lenses 20, in a sub-scanning direction on a polygon mirror 51. The condenser lens 40 is a common lens among the light beams BY, BM, BC, BK to pass there-through and is formed of a cylindrical entrance surface and a flat exit surface (see also FIG. 9).

As shown in FIG. 3, the deflector 50 includes the polygon mirror 51 and a motor 52. The polygon mirror 51 deflects the light beams passed through the coupling lenses 20 into the main scanning direction. The polygon mirror 51 is rotatable about the rotation axis X1, which extends in the first direction. The polygon mirror 51 has five deflection surfaces located at positions equally distanced from the rotation axis X1. The motor 52 may drive the polygon mirror 51 to rotate. The motor 52 is mounted on a base Fb1 of the frame F (see also FIG. 9).

The scanning optical system Lo forms images of the light beams deflected by the polygon mirror 51 on image surfaces. In particular, in the present embodiment, the scanning optical system Lo converges the light beams deflected by the polygon mirror 51 on image surfaces, which are surfaces of the photosensitive drums 200. The scanning optical system Lo is mounted on the frame F. The scanning optical system Lo includes a first scanning optical system LoY corresponding to yellow, a second scanning optical system LoM corresponding to Magenta, a third scanning optical system LoC corresponding to cyan, and a fourth scanning optical system LoK corresponding to black.

The first scanning optical system LoY and the second scanning optical system LoM are located on the one side in the third direction with respect to the polygon mirror 51. The third scanning optical system LoC and the fourth scanning optical system LoK are located on the other side in the third direction with respect to the polygon mirror 51. The light beams BY, Bm, BC, BK deflected by the polygon mirror 51 into the main scanning direction enter the first, second, third, and fourth scanning optical systems LoY, Lom, LoC, Lok, respectively.

The first scanning optical system LoY includes a first scanning lens 60YM, a second scanning lens 70Y, and a reflection mirror 81Y.

The first scanning lens 60YM refracts the light beams BY, BM deflected by the deflector 50 into the main scanning direction to focus the light beams BY, BM on the image surfaces. The first scanning lens 60YM has an fe characteristic, which causes the light casted by the deflector 50 on the image surfaces at a constant angular velocity to run at the constant velocity on the image surfaces. The first scanning lens 60YM is a scanning lens having an optical surface, which is located closest to the polygon mirror 51 among a plurality of optical surfaces included in the first scanning optical system LoY.

The reflection mirror 81Y reflects the light beam BY from the first scanning lens 60YM toward the image surface. The second scanning lens 70Y refracts the light beam BY reflected off the reflection mirror 81Y into the sub-scanning direction to form the image on the image surface. The second scanning lens 70Y is located at a position on the one side in the first direction with respect to the polygon mirror 51. The second scanning lens 70Y is located downstream from the first scanning lens 60YM in a traveling direction of the light beam BY and has an optical surface, which is closest to the image surface among the optical surfaces in the first scanning optical system LoY.

The second scanning optical system LoM includes the first scanning lens 60YM, a second scanning lens 70Y, a reflection mirror 81M, and a mirror 82M.

The first scanning lens 60YM is shared with the first scanning optical system LoY. The second scanning lens 70M and the reflection mirror 81M have the same functions as the second scanning lens 70Y and the reflection mirror 81Y in the first scanning optical system LoY. The mirror 82M reflects the light beam BM entering from the first scanning lens 60YM toward the reflection mirror 81M.

The third scanning optical system LoC is in a substantially axisymmetric configuration to the second scanning optical system LoM about the rotation axis X1 of the polygon mirror 51. In particular, the third scanning optical system LoC includes a first scanning lens 60CK, a second scanning lens 70C, a reflection mirror 81C, and a mirror 82C, which have the same functions as the first scanning lens 60YM, the second scanning lens 70Y, the reflection mirror 81M, and the mirror 82M in the second scanning optical system LoM.

The fourth scanning optical system LoK is in a substantially axisymmetric configuration to the first scanning optical system LoY about the rotation axis X1 of the polygon mirror 51. In particular, the fourth scanning optical system LoK includes the first scanning lens 60CK which is shared with the third scanning optical system LoC, a second scanning lens 70K, and a reflection mirror 81K, which have the same functions as the first scanning lens 60YM, the second scanning lens 70Y, and the reflection mirror 81Y in the first scanning optical system LoY.

The polygon mirror 51 deflects the light beams BY, BM, BC, BK toward the corresponding ones of the first through fourth scanning optical systems LoY, LoM, LoC, LoK, respectively. The light beam BY deflected toward the first scanning optical system LoY passes through the first scanning lens 60YM and is reflected off the reflection mirror 81Y, and further passes through the second scanning lens 70Y and exits toward the image surface on the one side in the first direction. The light beam BY is focused on the surface of the first photosensitive drum 200Y and scans the surface in the main scanning direction.

The light beam BM directed toward the second scanning optical system LoM passes through the first scanning lens 60YM and is reflected off the mirror 82M and the reflection mirror 81M, and further passes through the second scanning lens 70M and exits toward the image surface on the one side in the first direction. The light beam BM exits the second scanning lens 70M at a predetermined angle with respect to the first direction. The light beam BM is focused on the surface of the second photosensitive drum 200M and scans the surface in the main scanning direction. Similarly, the light beams BC, BK are directed toward the image surfaces, which are on the one side in the first direction, by the third and fourth scanning optical systems LoC, Lok, respectively, and are focused on the third and fourth photosensitive drums 200C, 200K and scan the surfaces in the main scanning direction.

Next, configurations of the frame F and the cover C1 will be described in detail.

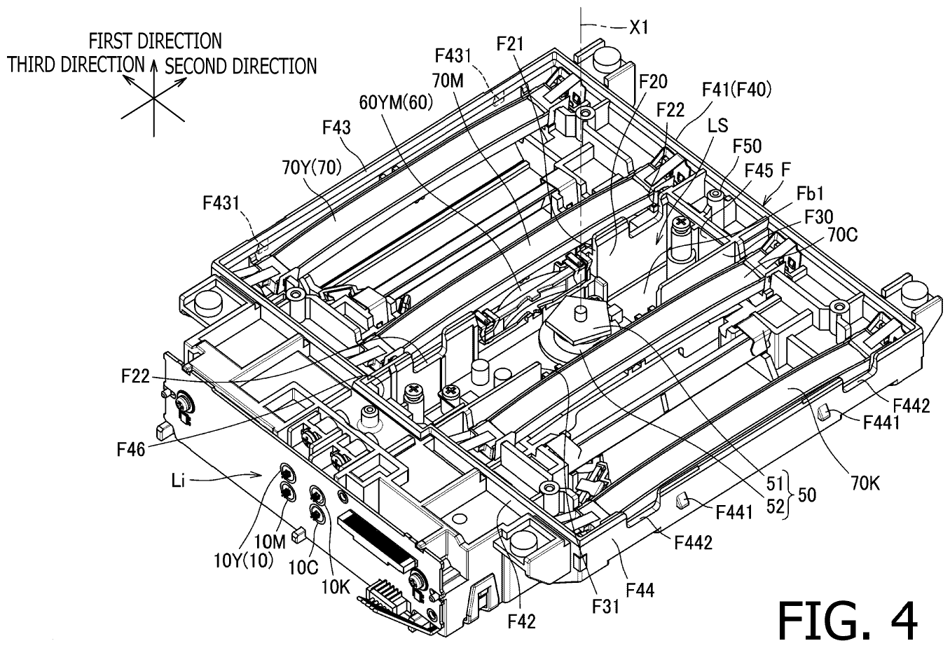

As shown in FIG. 4, the frame F is open on the one side in the first direction. The frame F includes a base Fb1 and an outer wall F40. The base Fb1 forms a bottom plane of the frame F. The base Fb1 is a board spreading orthogonally to the first direction. The outer wall F40 extends toward the one side in the first direction from peripheral edges of the base Fb1.

The outer wall F40 includes a first side-wall F41, a second side-wall F42, a third side-wall F43, and a fourth side-wall F44. The first side-wall F41, the second side-wall F42, the third side-wall F43, and the fourth side-wall F44 on four sides surround the scanning optical system Lo.

The first side-wall F41 and the second side-wall F42 are located apart from each other in the second direction. The deflector 50 is located between the first side-wall F41 and the second side-wall F42.

The second side-wall F42 is located between the semiconductor lasers 10 and the deflector 50. The first side-wall F41 is located on a side of the deflector 50 opposite to the semiconductor lasers 10.

The third side-wall F43 and the fourth side-wall F44 are located apart from each other in the third direction. The deflector 50 is located between the third side-wall F43 and the fourth side-wall F44. The third side-wall F43 is located on the one side in the third direction with respect to the deflector 50. The fourth side-wall F44 is located on the other side in the third direction with respect to the deflector 50.

The third side-wall F43 includes a first claw F431. The first claw F431 protrudes outward in the third direction from the frame F. The third side-wall F43 may include two (2) first claws F431 located at sideward positions in the second direction. In particular, one and the other of the first claws F431 are located on the one side and the other side, respectively, of the third side-wall F43 in the second direction.

The fourth side-wall F44 includes a second claw 441 and a second cutout F442. The second claw F441 protrudes outward in the third direction from the frame F. The fourth side-wall F44 may include two (2) second claws F441 located at sideward positions in the second direction. In particular, one and the other of the two second claws F441 are located on the one side and the other side in the second direction, respectively, of the fourth side-wall F44. The second cutout F442 is a cutout, or a notch, in a rectangular shape recessed from an edge of the fourth side-wall F44 on the one side toward the other side in the first direction. The fourth side-wall F44 may include two (2) second cutouts F442 located at sideward positions in the second direction. In particular, one and the other of the two second cutouts F442 are located on the one side and the other side in the second direction, respectively, of the fourth side-wall F44. In the second direction, the two second claws F441 are located between the two second cutouts F442.

The fourth side-wall F44 overlaps the second scanning lens 70K, which corresponds to black, in a view along the third direction. In the view along the third direction, the second cutouts F442, including the rectangular open areas inside the second cutouts F442, coincide with sideward regions in the second scanning lens 70K, which are apart from a center of the second scanning lens 70K in the second direction. Therefore, in a state where the cover C1 is removed from the frame F, the sideward regions that are apart from the center of the second scanning lens 70K in the second direction are exposed to an outside of the frame F through the second cutouts F442.

The frame F includes a first partition wall F20 being an example of the first wall, a second partition wall F30, a third partition wall F45, a fourth partition wall F46, and a boss F50.

The first partition wall F20, the second partition wall F30, the third partition wall F45, and the fourth partition wall F46 on four sides surround the deflector 50. The first partition wall F20, the second partition wall F30, the third partition wall F45, and the fourth partition wall F46 divide a chamber LS, which accommodates the deflector 50, from the other space inside the frame F. In other words, the first, second, third, and fourth partition walls F20, F30, F45, F46 surround the chamber LS accommodating the deflector 50 from the four sides.

The third partition wall F45 and the fourth partition wall F46 extend in a direction from the base Fb1 toward the cover C1. The third partition wall F45 and the fourth partition wall F46 are located apart from each other in the second direction. The third partition wall F45 is located toward the one side in the second direction with respect to the deflector 50. The fourth partition wall F46 is located toward the other side in the second direction with respect to the deflector 50. The fourth partition wall F46 forms a part of the second side-wall F42.

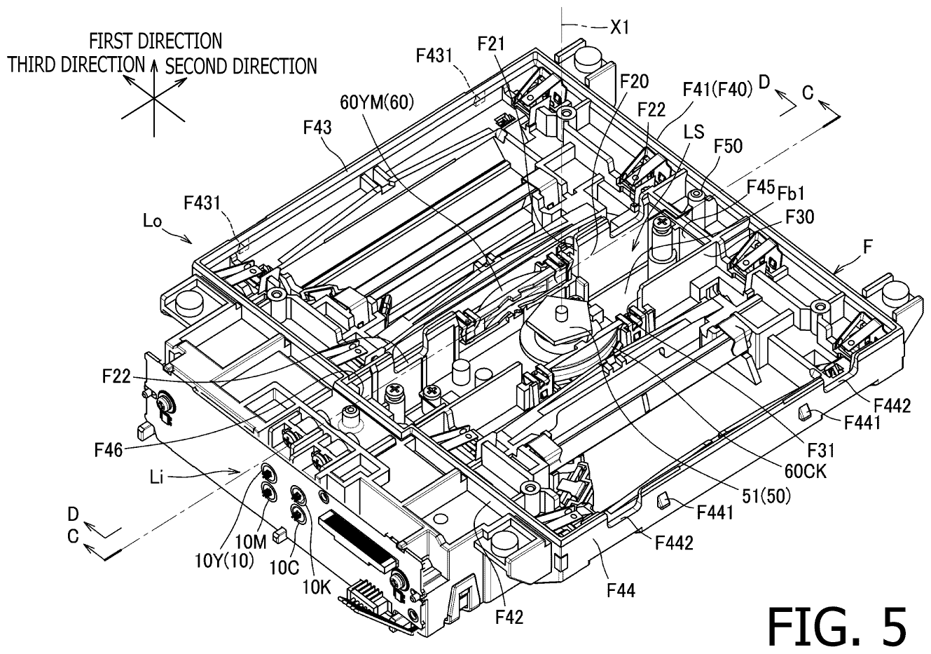

The first partition wall F20 is located toward the one side in the third direction with respect to the deflector 50 and connects the third partition wall F45 and the fourth partition wall F46. The first partition wall F20 extends in the direction from the base Fb1 toward the cover C1. In particular, the first partition wall F20 extends from the base Fb1 toward the one side in the first direction. As shown in FIGS. 3 and 4, in the view along the third direction, the first partition wall F20 overlaps the second scanning lens 70M. As shown in FIG. 5, the first partition wall F20 includes an opening F21 and a first cutout F22.

The opening F21 is in a rectangular shape and is located at a center of the first partition wall F20 in the second direction. The first scanning lens 60YM is situated in the opening F21 to close the opening F21. In this arrangement, the light beams BY, BM reflected off the polygon mirror 51 may pass through the opening F21 to travel toward the scanning optical systems LoY, LoM. In other words, the opening F21 is formed in a shape and a size corresponding to a scanning range of the light beams BY, BM.

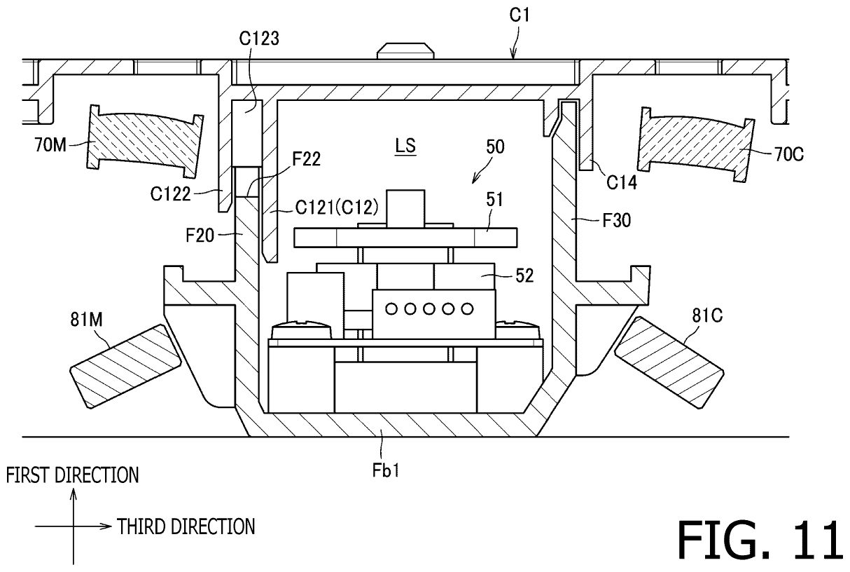

The first cutout F22 is a cutout, or a notch, in a rectangular shape. The first cutout F22 may include two (2) first cutouts F22, which are located on the one side and the other side in the second direction with respect to the opening F21. The two first cutouts F22 are located apart from the opening F21 in the second direction. As shown in FIG. 4, in the view along the third direction, the first cutouts F22, including the rectangular open areas inside the first cutouts F22, coincide with sideward regions in the second scanning lens 70M, which are apart from the center of the second scanning lens 70M in the second direction (see also FIG. 11). Through the first cutouts F22, in the state where the cover C1 is removed from the frame F, the sideward regions in the second scanning lenses 70M that are apart from the center in the second direction are exposed.

The second partition wall F30 is located on the other side in the third direction with respect to the deflector 50 and connects the third partition wall F45 and the fourth partition wall F46. The second partition wall F30 extends in the direction from the base Fb1 toward the one side in the first direction. As shown in FIGS. 3 and 4, in the view along the third direction, the second partition wall F30 overlaps the second scanning lens 70C. As shown in FIG. 5, the second partition wall F30 includes an opening F31.

The boss F50 is located between the first side-wall F41 and the third partition wall F45. The boss F50 is in a cylindrical shape and extends in the first direction. Among the parts that form the frame F, a tip of the boss F50 protrudes farthest from the base Fb1 on the one side in the first direction.

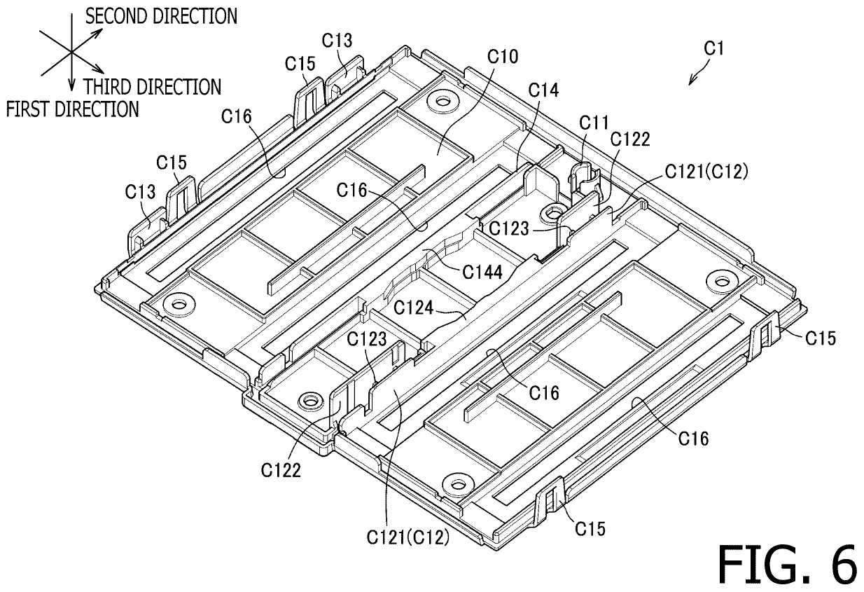

As shown in FIG. 6, the cover C1 includes a base part C10, a cylindrical part C11, a second wall C12, a third wall C13, a fourth wall C14, an engageable part C15, and a slit C16. The base part C10 is a board spreading orthogonally to the first direction.

The cylindrical part C11 is in a cylindrical shape. When the cover C1 is attached to the frame F, the boss F50 is inserted in the cylindrical part C11. The cylindrical part C11 may guide the boss F50 to a predetermined position when the cover C1 is being attached to the frame F.

The second wall C12 spreads orthogonally to the third direction. The second wall C12 extends from the base part C10 toward the other side in the first direction. As shown in FIG. 11, when the cover C1 is attached to the frame F, the second wall C12 overlaps the first partition wall F20 and, in conjunction with the first partition wall F20, divides a first recess CP1 into the chamber LS accommodating the deflector 50 and a space in which the second scanning lenses 70Y, 70M for yellow and magenta are located. The second wall C12 includes a first part C121, a second part C122, ribs C123, and an extended part C124.

As shown in FIG. 11, the first part C121 is located between the first partition wall F20 and the polygon mirror 51 in the third direction. The second wall C12 is located at least partly between the first partition wall F20 and the polygon mirror 51 in the third direction. As shown in FIG. 6, the second wall C12 may include two (2) first parts C121, which are in one-to-one correspondence with the first cutouts F22. Each of the first parts C121 is in a rectangular shape.

The second part C122 is located apart from the first part 121 in the third direction. The second wall C12 may include two (2) second parts C122, which are in one-to-one correspondence with the first parts S121. In particular, each second part C122 is located on the other side in the third direction with respect to of the corresponding one of the first parts C121. The second parts C122 are each in a rectangular shape. The second parts C122 extend in parallel to the first parts C121, and each of the second parts C122 faces the corresponding one of the first parts C121.

A dimension of the first part C121 in the first direction is greater than a dimension of the second part C122 in the first direction. As shown in FIG. 9, in the view along the third direction, in the state where the cover C1 is attached to the frame F, the first part C121 covers an entirety of the first cutout F22, including the rectangular open area inside the first cutout F22. In other words, the first part C121 closes the first cutout F22.

As shown in FIG. 11, in the state where the cover C1 is attached to the frame F, the first partition wall F20 is located between the first part C121 and the second part S122 in the third direction. In other words, the first partition wall F20 is located between at least a part of the second wall C12 and the polygon mirror 51.

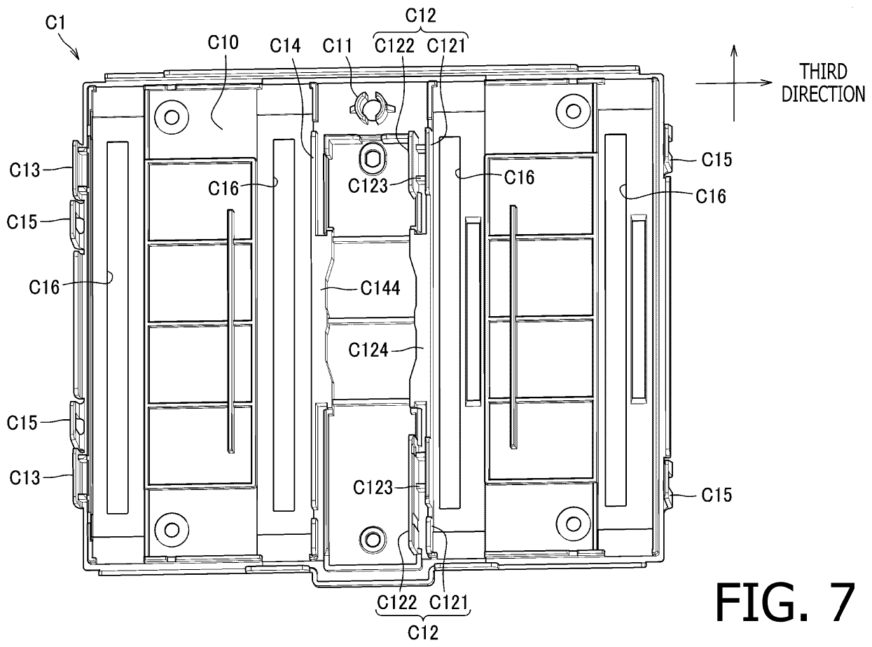

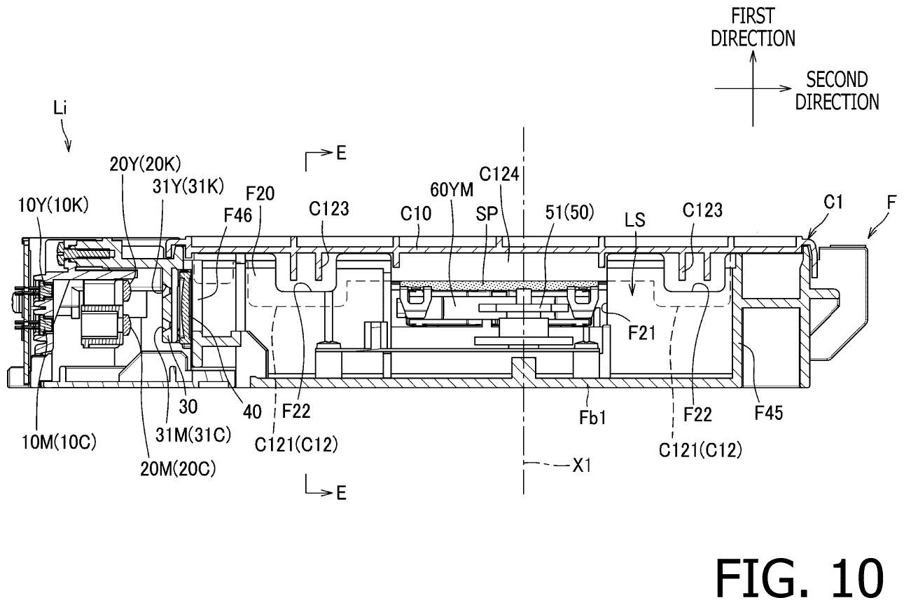

As shown in FIG. 7, each of the ribs C123 extends in the third direction and connects the first part C121 and the second part C122. As shown in FIG. 10, in the state where the cover C1 is attached to the frame F, the rib C123 is located at least partly inside the first cutout F22.

The cover C1 may include two (2) third walls C13 located on an edge of the base part C10 on the other side in the third direction. The third walls C13 extend from the base part C10 toward the other side in the first direction. The third walls C13 spread orthogonally to the third direction. The third walls C13 are each in a rectangular shape. As shown in FIG. 2, in the state where the cover C1 is attached to the frame F, in the view along the third direction, each third wall C13 covers an entirety of the corresponding one of the second cutouts F422, including the rectangular open area inside the second cutout F422.

Referring back to FIG. 6, the extended part C124 extends from the first parts C121 toward the other side in the third direction. The extended part C124 reduces a gap between the first scanning lens 60YM mounted in the opening F21 and the base part C10. In particular, as shown in FIG. 9, the first scanning lens 60YM located inside the opening F21 in the first partition wall F20 is pressed by the extended part C124 through a sponge SP to be fixed thereto. As such, the sponge SP fills the gap between the extended part C124 and the first scanning lens 60YM.

Referring back to FIG. 6, the fourth wall C14 spreads orthogonally to the third direction. The fourth wall C14 extends from the base part C10 toward the other side in the first direction. As shown in FIG. 11, in the state where the cover C1 is attached to the frame F, the fourth wall C14 overlaps the second partition wall F30 and, in conjunction with the second partition wall F30, divides the chamber LS that accommodates the deflector 50 from an area in which the second scanning lenses 70C, 70K for cyan and black are located, in the first recess CP1.

Referring back to FIG. 6, the fourth wall C14 includes an extended part C144. The extended part C144 extends toward the one side in the third direction. The extended part C144 functions in the substantially same manner as the extended part C124. In other words, the extended part C144 presses the first scanning lens 60CK situated in the opening F31 in the second partition wall F30 through a sponge SP (not shown).

The cover 1 may include a plurality of engageable parts C15. The engageable parts C15 are, in the state the cover C1 is attached to the frame F, engaged with the frame F. Two of the engageable parts C15 are located on one end of the base part C10 on the one side in the third direction, and another two of the engageable parts C15 are located on the other end of the base part C10 on the other side in the third direction. The engageable parts C15 extend from the base part C10 toward the other side in the first direction. Each engageable part C15 has a rectangular engageable hole, and in the state where the cover C1 is attached to the frame F, the engageable part C15 on the one side in the third direction engages with the first claw F431, and the engageable part C15 on the other side in the third direction engages with the second claws F441 (see also FIG. 2). The engageable parts C15 may guide the frame F to a correct attached position when the cover C1 is being attached to the frame F.

The cover C1 may have four (4) slits C16. The slits C16 are formed in the base part C10. The slits S16 longitudinally extend in the second direction. Through the slits C16, the light beams exiting the second scanning lenses 70 may pass and exit the cover C1. Optionally, translucent plates may be fitted in the slits C16.

As shown in FIG. 9, the cover C1 closes the opening of the frame F from the one side in the first direction. In other words, the cover C1 covers the polygon mirror 51 from the side opposite to the base Fb1.

Next, a part of a procedure to assemble the optical scanning apparatus 1 will be described. In particular, a procedure to mount the second scanning lenses 70 to the frame F and to attach the cover C1 to the frame F will be described.

When the optical scanning apparatus 1 is assembled, starting from a condition, as shown in FIG. 5, where none of the second scanning lenses 70 are mounted on the frame F, the four second scanning lenses 70 may be mounted on the frame F, as shown in FIG. 4. While a gap between the second scanning lens 70M and the first partition wall F20 may be considerably small, a worker may insert his/her fingers, tools, and/or robot arms in the first cutouts F22 to easily pinch the sideward regions of the second scanning lens 70M and mount the second scanning lens F70M on the frame F. Optionally, the position of the second scanning lens 70M may be adjusted by a shim interposed between the second scanning lens 70M and the frame F. Moreover, a gap between the second scanning lens 70K and the fourth side-wall F44 may be considerably small as well, but the worker may insert his/her fingers, the tools, and/or the robot arms in the second cutouts F442 to easily pinch the second scanning lens 70K and mount the second scanning lens 70K on the frame F. Furthermore, the position of the second scanning lens 70K may be adjusted by a shim interposed between the second scanning lens 70K and the frame F.

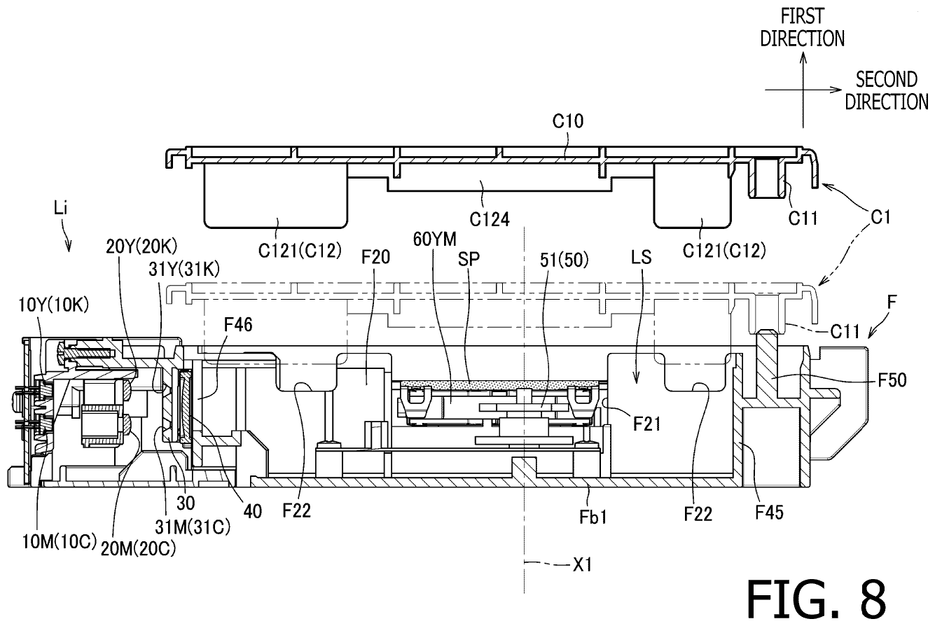

As shown in FIG. 8, after the second scanning lenses 70 are all mounted on the frame F, the cover C1 may be attached to the frame F. While the tip of the boss F50 protrudes farthest from the frame F toward the one side in the first direction, as the cover C1 approaches the frame F, the cylindrical part C11 of the cover C1 contacts the tip of the boss F50 firstly. Meanwhile, the second wall C12 may not yet be in contact the first partition wall F20.

After the cylindrical part C11 is engaged with the boss F50, as the cover C1 further approaches the frame F, tips of the four engageable parts C15 of the cover C1 may contact the third side-wall F43 and the fourth side-wall F44. With the tips of the engageable parts C15 contacting the third side-wall F43 and the fourth side-wall F44, the cover C1 is set in a correct orientation with respect to an axis, which is parallel to the rotation axis X1. As such, while maintaining the cover C1 in the correct orientation, the engageable parts C15 may guide the cover C1 to the attached position.

As the cover C1 reaches the attached position, the first claws F431 and the second claws F441 enter the engageable holes in the engageable parts C15. As such, the cover C1 may be prevented from being detached from the frame F easily.

According to the configuration described above, the present disclosure may be advantageous in the following aspects.

According to the present disclosure, the optical scanning apparatus 1 includes the first partition wall F20, the second partition wall F30, the third partition wall F45, and the fourth partition wall F46, which surround the chamber LS accommodating the deflector 50, inside the frame F. Meanwhile, for a worker to easily mount the second scanning lenses 70 on the frame F, the first partition wall F20 has the first cutouts F22. According to the present disclosure, in the state where the cover C1 is attached to the frame F, in the view along the third direction, the second walls C12 in the cover C1 cover the first cutouts F22 in the frame F; therefore, dust that may enter the chamber LS accommodating the deflector 50 through the first cutouts F22 may be reduced, and the dust to adhere to the polygon mirror 51 may be reduced.

Moreover, as shown in FIG. 11, the second walls C12 each have the first part C121 and the second part C122, which are located on the one side and the other side of the first partition wall F20 in the third direction. This arrangement may complicate routes for the dust to enter the chamber LS of the deflector 50; therefore, dust to enter the chamber LS of the deflector 50 through the first cutouts F22 may be reduced, and the dust to adhere to the polygon mirror 51 may be reduced.

Moreover, the second walls C12 each have the rib C123, which connects the first part C121 and the second part S122, and the rib C123 is located at least partly inside the first cutout F22. Therefore, the first part C121 and the second part C122 may be enhanced, and a dimensional accuracy of a gap between the first part and the second part C122 may be securely maintained. Accordingly, dust to enter the chamber LS of the deflector 50 through the first cutouts F22 may be reduced, and the dust to adhere to the polygon mirror 51 may be reduced.

Moreover, through the first cutouts F22, the second scanning lens 70 is partly exposed, and thereby the second scanning lens 70 may be mounted easily on the frame F. For example, the second scanning lens 70 may be mounted on the frame F easily by a worker inserting his/her fingers, tools, or robot arms in the first cutouts F22.

Moreover, the first scanning lens 60YM blocks the opening F21 in the first partition wall F20; therefore, dust that may enter the chamber LS accommodating the deflector 50 through the first cutouts F22 may be reduced, and the dust to adhere to the polygon mirror 51 may be reduced.

Moreover, when the cover C1 is being attached to the frame F, the boss F50 in the frame F is engaged with the cylindrical part C11 of the cover C1, and thereby the cover C1 may be guided to the attached position in the frame F. As such, the cover C1 may be easily attached to the frame F.

Moreover, the third walls C13 provided to the cover C1 cover the second cutouts F442 in the frame F, and thereby dust that may enter inside the frame F through the second cutouts F442 may be reduced, and the dust to adhere to the scanning optical system Lo may be reduced.

Moreover, through the second cutouts F442, the second scanning lens 70 is partly exposed to the outside of the frame F, and thereby the second scanning lens 70 may be mounted easily on the frame F. For example, the second scanning lens 70 may be mounted on the frame F easily by a worker inserting his/her fingers, tools, or robot arms in the second cutouts F442.

While the invention has been described in conjunction with the example structure outlined above and illustrated in the figures, various alternatives, modifications, variations, improvements, and/or substantial equivalents, whether known or that may be presently unforeseen, may become apparent to those having at least ordinary skill in the art. Accordingly, the example embodiment of the disclosure, as set forth above, is intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

For example, the frame F may not necessarily have the boss F50 extending in the first direction, or the cover C1 may not necessarily have the cylindrical part C11 to be inserted in the boss F50. In other words, the cover C1 may have the boss extending in the first direction, and the frame F may have the cylindrical part to be inserted in the boss.

For another example, the shape of the first cutouts F22 and/or the second cutouts F422 may not necessarily be limited to rectangle as long as the first cutouts F22 and/or the second cutouts F422 have a substantial size to allow the fingers of the worker, tools, and/or robot arms to enter. For example, the first cutouts F22 and/or the second cutouts F422 may be triangular or trapezoidal notches recessed from the edges of the first partition wall F20 and/or the fourth side-wall F44. Moreover, the shape of the second wall C12 and/or the third walls C13 may be changed according to the shape of the first cutouts F22 and/or the second cutouts F422, respectively.

For another example, the optical scanning apparatus according to the present disclosure may not necessarily be applied to a multicolor image forming apparatus but may be applied to a monochrome image forming apparatus, in which a single light beam alone may scan an image surface.

What is claimed is:

1. An optical scanning apparatus, comprising:
a semiconductor laser;
a coupling lens configured to convert light emitted from the semiconductor laser into a light beam;
a deflector configured to deflect the light beam passed through the coupling lens into a main scanning direction, the deflector including a polygon mirror, the polygon mirror being rotatable about a rotation axis extending in a first direction;
a scanning optical system configured to form an image of the light beam deflected by the deflector on an image surface;
a frame including a base board, on which the deflector is mounted; and
a cover covering the deflector from a side opposite to the base board,
wherein the frame includes a first wall extending in a direction from the base board toward the cover, the first wall including an opening, through which the light beam deflected by the deflector toward the scanning optical system passes, and a first cutout located apart from the opening in a second direction, the second direction being parallel to the main scanning direction,
wherein the cover includes a second wall, the second wall covering an entirety of the first cutout in a view along a third direction, the third direction intersecting orthogonally with the first direction and the second direction.

2. The optical scanning apparatus according to claim 1, wherein the second wall is at least partly located between the first wall and the deflector in the third direction.

3. The optical scanning apparatus according to claim 1, wherein the first wall is located between at least a part of the second wall and the deflector in the third direction.

4. The optical scanning apparatus according to claim 1, wherein
the second wall includes:
a first part located between the first wall and the deflector in the third direction; and
a second part located apart from the first part in the third direction, and
the first wall is located between the first part and the second part in the third direction.

5. The optical scanning apparatus according to claim 4, wherein a dimension of the first part in the first direction is greater than a dimension of the second part in the first direction.

6. The optical scanning apparatus according to claim 4, wherein
the second wall includes a rib, the rib connecting the first part and the second part, and
the rib is located at least partly inside the first cutout.

7. The optical scanning apparatus according to claim 1, wherein
the scanning optical system includes a first scanning lens and a second scanning lens, the second scanning lens being located downstream from the first scanning lens in a traveling direction of the light beam,
the first wall overlaps the second scanning lens in a view along the third direction, and
the first cutout overlaps a sideward region of the second scanning lens in the view along the third direction, the sideward region being apart from a center of the second scanning lens in the second direction.

8. The optical scanning apparatus according to claim 7, wherein the first scanning lens is situated to close the opening.

9. The optical scanning apparatus according to claim 1, wherein
one of the frame and the cover includes a boss, the boss extending in the first direction, and
the other of the frame and the cover includes a cylindrical part, in which the boss is configured to be inserted when the cover is attached to the frame.

10. The optical scanning apparatus according to claim 1, wherein
the frame includes an outer wall, the outer wall extending in the first direction and surrounding the scanning optical system, and
the cover includes an engageable part configured to engage with the frame in a state where the cover is attached to the frame.

11. The optical scanning apparatus according to claim 10, wherein
the outer wall includes a second cutout, and
the cover includes a third wall, the third wall covering an entirety of the second cutout in a view along the third direction.

12. The optical scanning apparatus according to claim 11, wherein
the scanning optical system includes a first scanning lens and a second scanning lens, the second scanning lens being located downstream from the first scanning lens in a traveling direction of the light beam,
the outer wall overlaps the second scanning lens in the view along the third direction, and
the second cutout overlaps a sideward region of the second scanning lens in the view along the third direction, the sideward region being apart from a center of the second scanning lens in the second direction.

13. An optical scanning apparatus, comprising:
a light source emitting a light beam;
a polygon mirror deflecting the light beam into a main scanning direction, the polygon mirror being rotatable about a rotation axis;
a motor rotating the polygon mirror;
a scanning optical system converging the light beam deflected by the polygon mirror on an image surface;
a frame including a base board, on which the motor is mounted; and
a cover covering the polygon mirror from a side opposite to the base board,
wherein the frame includes a partition wall extending in a direction from the base board toward the cover, the partition wall surrounding a chamber which accommodates the polygon mirror, the partition wall including a first cutout located outside of a scanning range of the light beam in the main scanning direction, and
wherein the cover includes a second wall, the second wall closing the first cutout.
